(19) United States
(12) Patent Application Publication
(10) Pub. No.: US 2015/0095029 A1
(43) Pub. Date: Apr. 2, 2015

(54) Computer-Implemented System And Method For Quantitatively Assessing Vocal Behavioral Risk

(71) Applicant: StarTek, Inc., Greenwood Village, CO (US)

(72) Inventors: Ted Nardin, Lutz, FL (US); James Keaten, Lutz, FL (US)

(73) Assignee: StarTek, Inc., Greenwood Village, CO (US)

(21) Appl. No.: 14/044,807

(22) Filed: Oct. 2, 2013

(51) Int. Cl. G10L 17/26

(52) U.S. Cl. CPC G10L 17/26
USPC 704/249

(57) ABSTRACT

Engaging persona candidates are provided with a skills assessment that includes vocal behavior. Each candidate provides both scripted and spontaneous answers to questions in a situational setting that closely matches the daily demands of the customer support industry. Samples of the candidate's speech are evaluated to identify distinct voice cues that qualitatively describe speech characteristics, which are scored based on the candidate's spoken performance. One or more of the voice cues are mapped to phonetic analytics that quantitatively describe vocal behavior. Each voice cue also has an assigned weight. The voice cue scores for each phonetic analytic are multiplied by their assigned weights and added together to form a weighted phonetic analytic, which is then used to form a part of the vocal behavior risk assessments.

### FIELD

This application relates in general to vocal behavior assessment and, in particular, to a computer-implemented system and method for quantitatively assessing vocal behavioral risk.

### BACKGROUND

Customer service remains a critical part of product and service support for all companies in every industry, from retail to field operations, whether provided before, during or after an actual sale or transaction or, on a broader scale, as a part of doing business with the public. Indeed, at a time where e-commerce has increasingly supplanted traditional brick-and-mortar storefronts, customer service may be the only contact between a customer (or potential customer) and a company. Customer service personnel with only marginal vocal behavior skills can frustrate, alienate or even cause a customer to leave. As a result, predicting the vocal behavior of personnel deployed in a customer service, technical support or similar environment, on top of accurately assessing overall comprehension and dialogue skills, has become a critical aspect of ensuring that one-on-one customer service provisioning remains of the best possible quality. Customer service personnel are often labeled based on their particular industry. For instance, call centers refer to customer service personnel as agents, while the banking industry sometimes uses account management specialists. Regardless of label, for the sake of clarity and generality, except as noted otherwise, customer service personal will be referred to herein as “engaging persona” without reference to a specific industry or job description.

Existing approaches to evaluating the vocal behavior skills of customer service personnel focus on weeding out individuals who fail to meet a threshold performance level, as usually measured by automated voice analysis software. For instance, SHL, London, UK provides a multi-tiered suite of semi-automated assessments for evaluating candidates for call center roles. Similarly, The Berlitz Corporation, Princeton, N.J., offers an over-the-telephone oral proficiency interview that tests active speaking skills. Finally, Knowledge Technologies, Menlo Park, Calif., offers the Versant line of speaking tests that use speech processing and linguistic analysis to evaluate the speaking skills of non-native English speakers. These kinds of automated assessments generally evaluate voice analytics that include inflection, tonal quality, rate of speech, and pronunciation by identifying indications of each kind of voice analytic within the candidate's speech. However, these systems emphasis throughput and testing expediency and their automated nature can be readily gamed, such as when the individual sings, rather that speaks, responses to disguise a foreign accent and artificially raise inflection and tonal quality. Moreover, the screen-and-eliminate aspect typical of these tests can provide false assurances that a particular candidate has the necessary native-language speaking requisites to perform successfully as a customer service person.

Therefore, a need remains for an approach to providing an evaluation of the native-language vocal skills of customer service personnel that is resilient to testing artifices and that provides an assessment based on degree of potential risk.

### SUMMARY

Engaging persona candidates are provided with a skills assessment that includes vocal behavior. Each candidate provides both scripted and spontaneous answers to questions. Samples of the candidate's speech are evaluated to identify distinct voice cues that qualitatively describe speech characteristics, which are scored based on the candidate's spoken performance. One or more of the voice cues are mapped to phonetic analytics that quantitatively describe vocal behavior. Each voice cue also has an assigned weight. The voice cue scores for each phonetic analytic are multiplied by their assigned weights and added together to form a weighted phonetic analytic, which is then used to form a part of the vocal behavior risk assessments.

One embodiment provides a computer-implemented system and method for quantitatively assessing vocal behavioral risk. A plurality of vocal cues that qualitatively describe speech characteristics and phonetic analytics that quantitatively describe vocal behavior are defined. One or more of the voice cues are mapped to each phonetic analytic and a weight is assigned to each of the mapped voice cues. Spoken voice samples provided by an engaging persona candidate are stored. Scores assigned to the spoken voice samples for each of the voice cues are assembled and the phonetic analytics are calculated as a function of the scores for each mapped voice cue and the mapped voice cue's assigned weight. A vocal behavior risk assessment is formed from the phonetic analytics.

Still other embodiments will become readily apparent to those skilled in the art from the following detailed description, wherein are described embodiments by way of illustrating the best mode contemplated. As will be realized, other and different embodiments are possible and the embodiments' several details are capable of modifications in various obvious respects, all without departing from their spirit and the scope. Accordingly, the drawings and detailed description are to be regarded as illustrative in nature and not as restrictive.

### BRIEF DESCRIPTION OF THE DRAWINGS

FIG. 1 is a block diagram showing a computer-implemented system for quantitatively assessing vocal behavioral risk, in accordance with one embodiment.

FIG. 2 is data flow diagram showing engaging persona candidate assessment.

FIG. 3 is a screen shot showing, by way of example, a graphical user interface providing assessment results for an engaging persona candidate.

FIG. 4 is a screen shot showing, by way of example, a graphical user interface for organizing and finding engaging persona candidate auditions.

FIG. 5 is a flow diagram showing a method for quantitatively assessing vocal behavioral risk, in accordance with one embodiment.

FIG. 6 is a flow diagram showing a routine for scoring spoken voice samples for use in conjunction with the method of FIG. 5.

### DETAILED DESCRIPTION

Accurately gauging vocal behavior is a key part of the overall process of evaluating candidates for jobs that require strong interpersonal communications skills, such as needed by customer service or technical support engaging personas, as well as to ensure that deployed engaging personas continue to provide the highest possible level of service. However, high-scoring vocal behavior skills alone are no guarantee of success, while at the same time, a poor showing on a battery of vocal behavior tests does not necessarily imply that a candidate is unsuitable to be an engaging persona

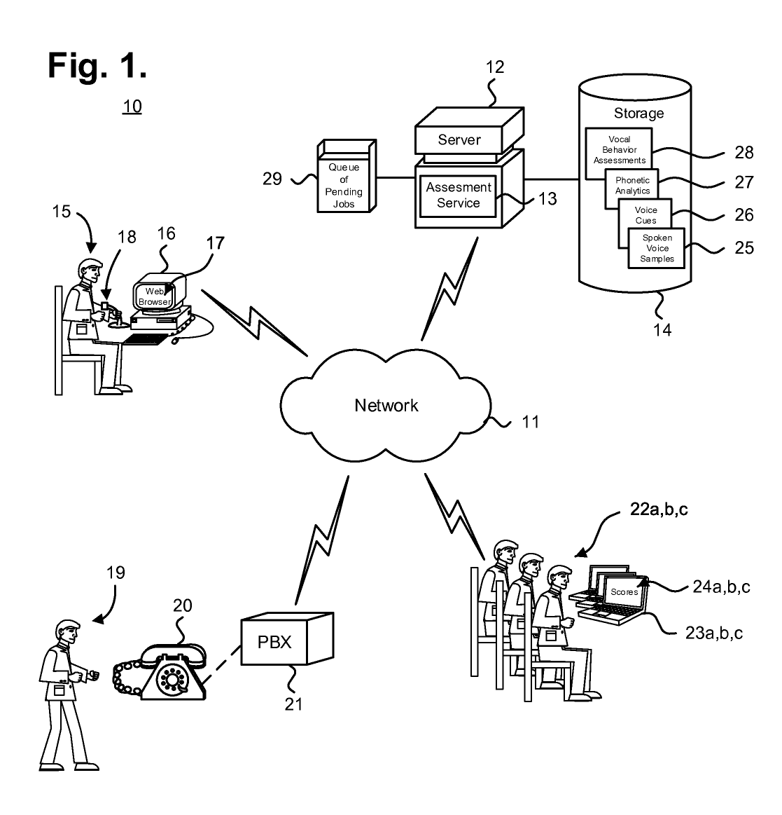

Instead of relying wholly upon a pass-or-fail type of job interview metric, vocal behavior abilities are best viewed as a combination of different, albeit complimentary, speaking skills of strengths and weaknesses that vary from individual to individual. As such, an individual may show stronger abilities in some areas of vocal behavior than in other areas, which provides a better indication of how the individual would perform overall and under particular circumstances. FIG. 1 is a block diagram showing a computer-implemented system 10 for quantitatively assessing vocal behavioral risk, in accordance with one embodiment. The method evaluates the native-language vocal skills of an engaging persona or engaging persona candidate based on a degree of potential risk. For clarity of discussion, the terms engaging persona and engaging persona candidate will be used interchangeably, unless otherwise indicated.

An engaging persona candidate skills assessment is provided through a Web-based assessment service 13. The testing of engaging persona candidates by the assessment service 13 is administered through a centralized server 12 that can be remotely accessed via the Web, or similar protocol, over a wide area public data communications network 11, such as the Internet, or other form of data communications network, using wired or wireless connections. The server 12 is operatively coupled to a storage device 14, within which is stored spoken voice samples 25 provided by engaging persona candidates 15 during testing, plus data used by the assessment service 13, including a plurality of voice cues 26 that qualitatively describe speech characteristics and phonetic analytics 27 that quantitatively describe vocal behavior. Based on completed skills assessments, the assessment service 13 generates vocal behavior risk assessments 28, which can also be stored in the storage device 14. Both the server 12 and personal computer 16 include components conventionally found in general purpose programmable computing devices, such as a central processing unit, memory, input/output ports, network interfaces, and non-volatile storage, although other components and computational components are possible.

To perform a skills assessment, an engaging persona candidate 15 interfaces with the server 12 through a Web browser 17 executing on a personal computer 16 or similar device. The personal computer 16 includes a microphone 18 or similar speech input device through which the engaging persona candidate 15 can provide spoken voice samples in response to the questions asked by the assessment service 13. In a further embodiment, the skills assessment can be provided as a call-in telephone service. An engaging persona candidate 19 can interact with the server 12 using a telephone 20 through a public exchange system (PBX) 21 or similar device that is interfaced via the network 11 and which converts voice over Plain Old Telephone Service (POTS) into digital form for processing by the server 12. Alternatively, the telephone 20 could be interfaced directly with the server 12 through a public exchange (not shown) or similar device located locally. In a still further embodiment, the skills assessment can be provided in digital form using VoIP (Voice Over Internet Protocol) or similar voice communications standard for providing voice over a network 11, in lieu of a conventional telephone. Still other ways of providing an engaging persona candidate 15 with an interface to the server 12 for performing a skills assessment are possible.

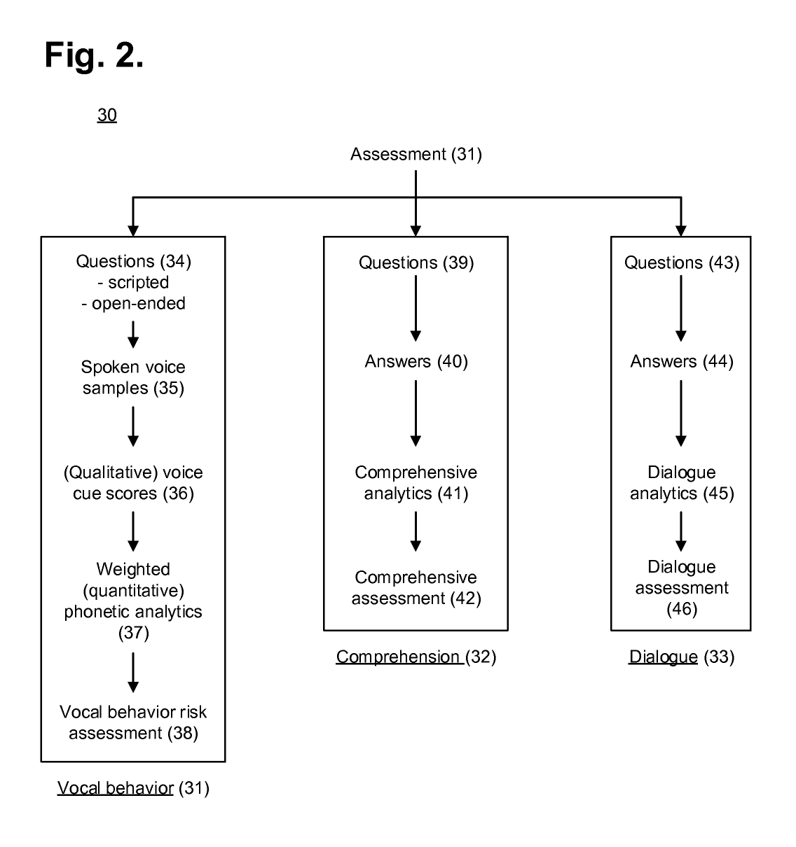

When taking a skills assessment, the engaging persona candidate 15 provides spoken voice samples 25, along with other responses, that are centrally stored in the storage device 14 for further processing. FIG. 2 is data flow diagram 30 showing engaging persona candidate assessment. Each skills assessment 31 can include evaluations of an engaging persona candidate's vocal behavior 31, comprehension 32 and dialogue 33. Other kinds of evaluations of skills are possible.

The vocal behavior assessment 31 quantifies vocal ability in a manner usable for various purposes, including job candidate screening instrument or training diagnostic for deployed engaging personas. During testing, an engaging persona candidate 15 must provide answers to both scripted prose and open-ended questions 34. The individual's responses are collected and stored by the server 12 as the spoken voice samples 35. The scripted prose tests standard phonetics and contains phonemes found in standard spoken American English (or whichever language or language derivative is being tested). The open-ended questions solicit unscripted spontaneous speech from the candidate.

The assessment service 13 then determines the individual's social competence in terms of vocal behavior 31 through a two-part analysis. First, each spoken voice sample 35 is assigned qualitative scores 36 from the voice cues 26 (show in FIG. 1) that discretely rate the engaging persona candidate's speech by indicia representing the acoustic spectrum producible by the human voice. In one embodiment, the qualitative scores 36 are assigned manually by raters who listen to each spoken voice sample 35 and grade the individual's speech along a discrete scale for each of the voice cues. Manual scoring by human raters helps guard against false results and gaming through testing artifices, such as singing, rather than speaking. In a further embodiment, the qualitative scores 36 can be assigned through automated voice processing. Still other ways of qualitatively scoring the spoken voice samples 35 are possible.

Each of the voice cues 26 qualitatively describes a type of speech characteristic. The voice cues 26 include, for instance, articulation accuracy, voice quality, vocal variety, fluency, and vocal emphasis. Articulation accuracy refers to the ability to produce all the phonemes found in standard American English with enough mechanical precision to result in a high likelihood of correct recognition by a native speaker. Voice quality denotes the cross-phonetic resonance patterns created when pulsations of the vocal folds reverberate in distinct body cavities, for instance, nasal, oral, thoracic, and so on. Vocal variety refers to the way vocal utterances change within and across speech segments allowing for the perception of melody and rhythm. Fluency corresponds to how silence, that is, cessation of sound, is used, or not used, during vocal utterances, especially how speech segments, for instance, words, phrases, sentences, and so on, are punctuated through silence. Vocal emphasis refers to the relationship between conceptual importance and acoustic conspicuousness, as signaled through an abrupt yet momentary change in vocal dynamics, that is, amplitude shift, alteration of fundamental frequency. Still other voice cues of a more specific or general nature could be used, either in addition to or in lieu of the foregoing voice cues.

A rater assigns a score selected from a discrete continuum of possible scores for each voice cue 26. The possible scores are selected to ensure reliable and statistically valid ratings, independent of the particular vagaries and idiosyncrasies of each rater. For instance, a score between ‘1’ and ‘5’ may be possible for the voice cue 26 of voice quality, with ‘1’ being incomprehensible speech and ‘5’ representing speech on par with a network news anchor. Alternatively, the possible scores could be set up to ensure rater consistency. For example, a pairing of voice cues of “voice quality high” and “voice quality low” could be used as a form of rater sanity check, where high scores for both “voice quality high” and “voice quality low” would flag an inconsistency in scoring and trigger, for instance, further follow up or invalidation of that voice cue score. Other discrete continuums of possible scores are possible.

Referring back to FIG. 1, in a further embodiment, the scoring of the spoken voice samples 25 by a set of raters 22a,b,c can be centrally managed by the assessment service 13. The spoken voice samples 25 collected by the server 12 are placed into a queue of pending jobs 29 and offered to the raters 22a,b,c for qualitative scoring. Each rater 22a,b,c, can be allowed to select any of the pending jobs to score using, for instance, a personal computer 23a,b,c or similar device. Alternatively, the raters 22a,b,c can be instructed to choose a pending job from the queue 29 in a particular order, such as first-in/first-out (FIFO). Once a pending job has been accepted, the spoken voice sample 25 is visually removed from the queue 29 to prevent selection by other raters 22a,b,c. The rater 22a,b,c listens to the selected spoken voice sample 25 and assigns scores 24a,b,c for each voice cue 26, which are provided back to the assessment service 13.

To ensure that all of the spoken voice samples 25 in the queue 29 are scored, the assessment service 13 tracks each sample following removal from the queue 29. Acceptance of a pending job by a rater 22a,b,c will be nullified after the expiry of a preset amount of time, or based on other criteria, after which the spoken voice sample 25 will again appear in the queue 29 as a pending job. The same rater 22a,b,c could chose that re-queued spoken voice sample 25, or chose a different one. Alternatively, a rater 22a,b,c who has exceeded the preset amount of time allotted to score a selected spoken voice sample 25 could be penalized, such as by being disallowed from choosing the same sample again.

In a still further embodiment, the plurality of service levels can be offered by the assessment service 13, which including ensuring the timeliness of the scoring of the spoken voice samples 25. For example, for patrons requiring an enhanced level of service, the spoken voice samples 25 could be visually prioritized in the queue 29 to expedite their selection by the raters 22a,b,c, Similarly, the service levels could be based on time-to-completion, or other criteria, such that a risk assessment will be delivered within a promised time frame. For instance, the highest service level could promise completed skills assessments within an hour of the engaging persona candidate's interview. That would require that each spoken voice sample 25 be placed at the top of the queue 29 upon arrival from the candidate's computer 16. Moreover, the assessment service 13 will track the selected spoken voice samples 25 in a more proactive fashion; if a promised time-to-completion has been exceeded, or is in danger of being exceeded, an overdue scoring can be escalated, for instance, by bringing the matter to the attention of supervisory staff or by preempting the scoring of other already-selected spoken voice samples 25, so that the overdue spoken voice sample 25 can be scored right away. For example, the preset amount of time allotted for a rater 22a,b,c to score the spoken voice sample 25 could be minimal, perhaps five minutes or less, to ensure that scoring happens in an expeditious manner. Still other kinds of service levels and features are possible.

The scoring of the different voice cues 26 for the spoken voice samples 25 is only the first part of the two-part analysis. During the second part, the scores 24a,b,c are transformed into quantitative risk assessments 28 based on phonetic analytics 27 that quantitatively describe vocal behavior. Referring back to FIG. 2, the qualitative scores 36 for each of the voice cues 26 (shown in FIG. 1) are centrally collected by the assessment service 13. One or more of the voice cues 26 are mapped to each phonetic analytic 25 and each of the mapped voice cues 26 is assigned a weight. The voice cues 26 and their weights are calibrated to match specific requirements of the work environment for which the candidate is interviewing and are intended to measure general job-related characteristics, such as effectiveness, friendliness and efficiency, as well as specific voice behaviors, like dialogue ability and disposition.

The voice cues 26 evaluated in each candidate's speech are qualitatively scored in a situational setting that closely matches the daily demands of the customer support industry, and then are quantitatively combined and weighted to stress possessing an ability to sustain a conversation over a long period of time. Each weighting is on a normalized scale between 0 and 1. Weightings for articulation accuracy can range from 0.60 to 0.91, although other ranges could be used. Weightings for voice quality can range from 0.44 to 0.85, although other ranges could be used. Weightings for vocal variety range from 0.54 to 0.89, although other ranges could be used. Weightings for fluency range from 0.57 to 0.81, although other ranges could be used. Weightings for vocal emphasis range from 0.49 to 0.79, although other ranges could be used.

In one embodiment, both a constant and multiplier in the calculation of an aggregate Score are used to ensure that 0 is the lowest score possible and 100 is the highest score possible, such that:

Score={[Constant+(AA×Weight)+(VQ×Weight)+(VV×Weight)+(F×Weight)+(VE×Weight)]×Multiplier}

where Constant≅−3.0, AA represents the qualitative score for articulation accuracy, VQ represents the qualitative score for voice quality accuracy, F represents the qualitative score for fluency, VV represents the qualitative score for vocal variety, F represents the qualitative score for fluency, VE represents the qualitative score for vocal emphasis, and Multiplier≅3.7037. Other constants and multipliers could be used.

For each phonetic analytic 25, the (qualitative) voice cue scores 36 for that analytic are multiplied by their assigned weights and added together to form a weighted (quantitative) phonetic analytic 37, which is then used to form a part of the vocal behavior risk assessments 38. For example, a score falling within the Blue color band would be evaluated as:

{[−3+(10×0.6)+(9×0.5)+(10×0.5)+(8×0.8)+(8×0.6)]×3.7037}=87.8

A score falling within the Red color band would be evaluated as:

{[−3+(3×0.6)+(6×0.5)+(2×0.5)+(6×0.8)+(4×0.6)]×3.7037}=37.0

The risk assessments 38 provides an assessment based on degree of potential risk, and not on a screen-and-eliminate basis. In one embodiment, phonetic analytics 25 for vocal engagement and vocal clarity are generated as vocal behavior risk assessments 38. The phonetic analytics 25 are defined for assessing an ability to effectively communicate verbally in American-spoken English, although phonetic analytics could be defined for other language derivatives, such as Canadian-spoken English, British-spoken English, Australian-spoken English, and New Zealand-spoken English, and other languages altogether, such as continental French and Canadian-spoken French. The vocal engagement phonetic analytic quantifies the risk of an engaging persona candidate in terms of vocal prosody, such as melodiousness of speech, rhythm and tone. The vocal clarity phonetic analytic quantifies the engaging persona candidate's risk in terms of vocal clarity, which focuses on the mechanics of speech. Both of these phonetic analytics are gradated along a discrete color-coded scale, ranging from blue (high achievement), to green (moderate-high achievement), to yellow (moderate achievement), to orange (moderate-low achievement), to red (low achievement), although other types of grading and risk assessments could be used, as well as other forms of vocal behavior risk assessments in general.

Vocal behavior 31 is one part of the overall assessment 31 of an engaging persona candidate. In addition, both comprehension 32, which measures the individual's ability to understand, and dialogue 33, which measure the individual's disposition during conversation, can be evaluated. Note that the dialogue skills 33 being tested here are different than the vocal behavior skills 31, as the former uses a purely machine-based approach that quantitatively measures an ability to engage in conversation, whereas the vocal behavior skills assessment is a hybrid approach combining qualitative and quantitative measures. During testing of comprehension 32 and dialogue 33, the engaging persona candidate must respectively provide answers 40, 44 to questions 39, 43 that are evaluated through comprehensive and dialogue analytics 41, 45 to generate comprehensive and dialogue assessments 42, 46. Still other types of skills assessments are possible.

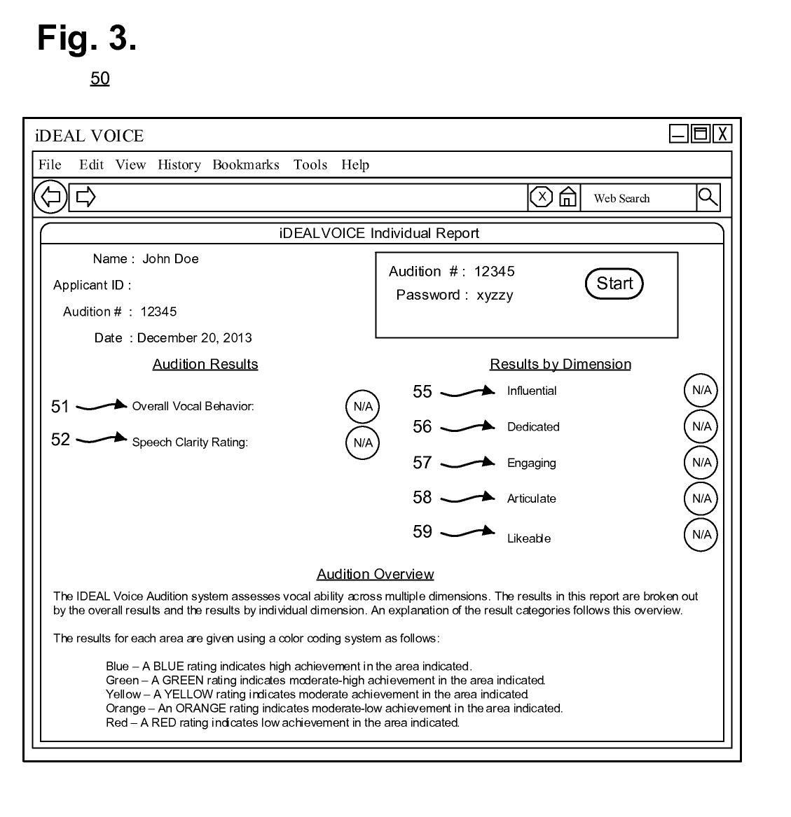

The results of each skills assessment can also be provided through a Web-based interface. FIG. 3 is a screen shot showing, by way of example, a graphical user interface 50 providing assessment results for an engaging persona candidate. The vocal prosody and vocal clarity types of vocal behavior risk assessments 38 are presented as part of a set of audition results, here, respectively termed “Overall Vocal Behavior” 51 and “Speech Clarity Rating” 52. Finally, vocal ability across multiple dimensions, including influential 55, dedicated 56, engaging 57, articulate 58, and likeable 59, can be provided.

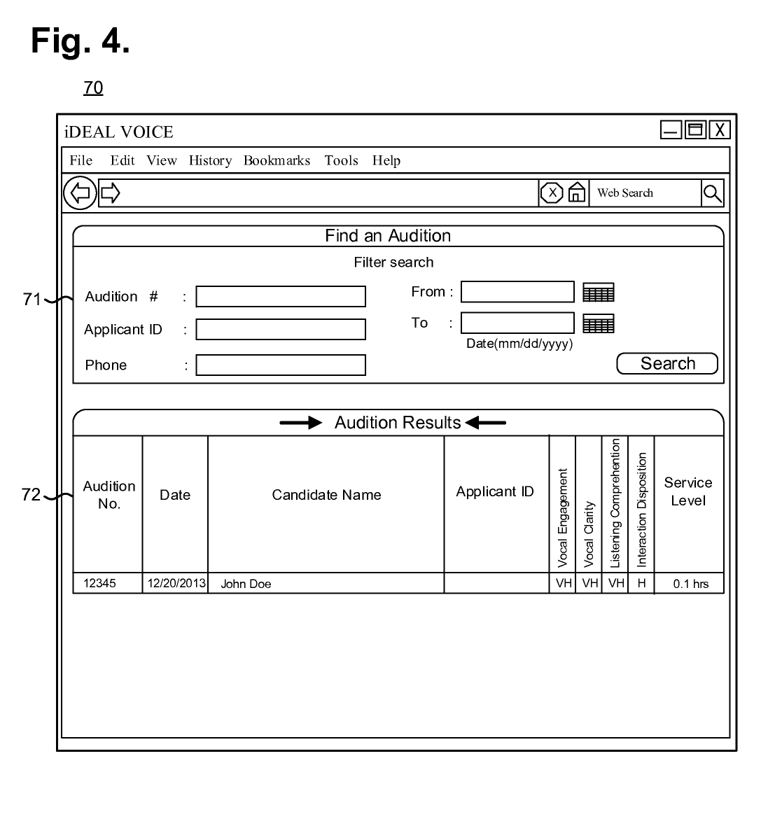

In addition, the assessment service 13 facilitates scoring and review of skills assessments through a Web-based interface. FIG. 4 is a screen shot showing, by way of example, a graphical user interface 70 for organizing and finding engaging persona candidate auditions. Auditions of individual engaging persona candidates can be searched by entering identifying criteria in a filter search dialogue box 71, in response to which the assessment service 13 will present any audition results found in an accompanying audition results dialogue box 72.

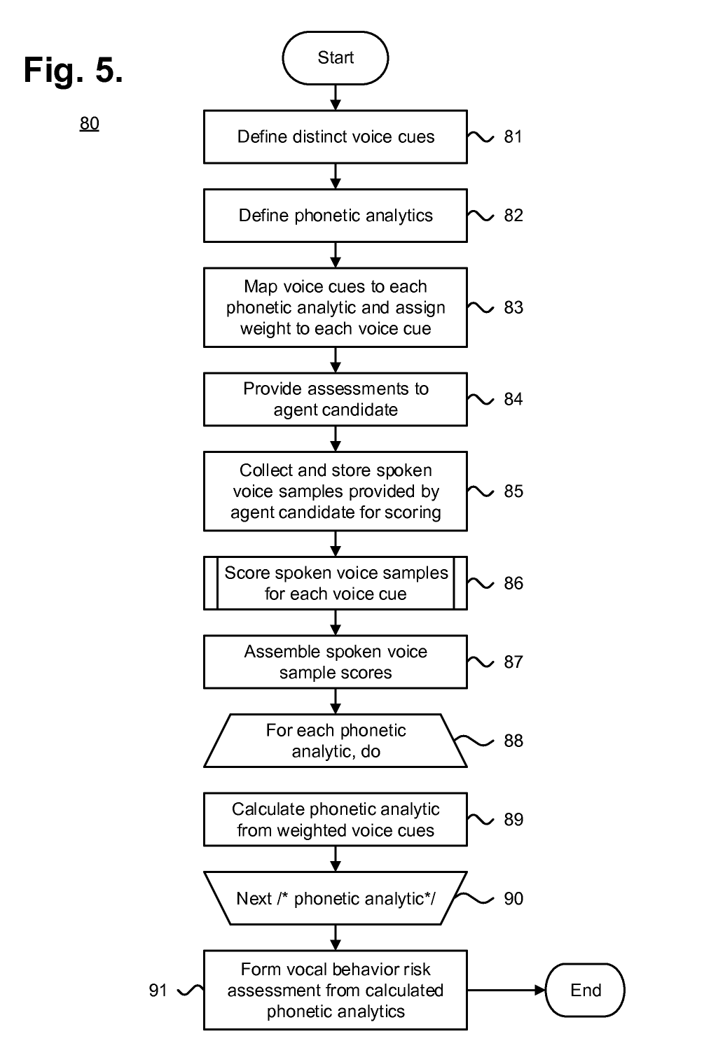

The assessment service 13 is centrally executed by the server 12 and is accessed by remote clients, such as an engaging persona candidate's computer 16 or similar device over a network 11 using a Web browser 17 or similar application. FIG. 5 is a flow diagram showing a method for quantitatively assessing vocal behavioral risk, in accordance with one embodiment. The parking service 12 are supported by a set of services (not shown). The assessment service 13 is implemented in software and execution of the software is performed as a series of process or method modules or steps.

Initially, the vocal behavioral models are set up. First, a plurality of voice cues 26 that qualitatively describe speech characteristics are defined (step 81). Similarly, phonetic analytics 27 that quantitatively describe vocal behavior are defined (step 82). One or more of the voice cues 26 are mapped to each phonetic analytic 27 and each mapped voice cue is assigned a weight (step 83). Each weight represents the amount of influence that a mapped voice cue 26 has on a particular phonetic analytic 27.

During each job interview (or deployed engaging persona evaluation), the assessment service 13 provides questions 34, 39, 43 for a skills assessments 31 to an engaging persona candidate 15 through their computer 16 or similar device (step 84). Depending upon which part of the skills assessment 31 is being performed, that is, vocal behavior 31, comprehension 32 and dialogue 33, the engaging persona candidate 15 provides an appropriate form of response back to the assessment service 13. Focusing only on the vocal behavior skills 31 portion of the assessment 31, the spoken voice samples 35 provided by the engaging persona candidate 15 are collected and stored by the server 12 into the storage device 14 (step 85) for further processing.

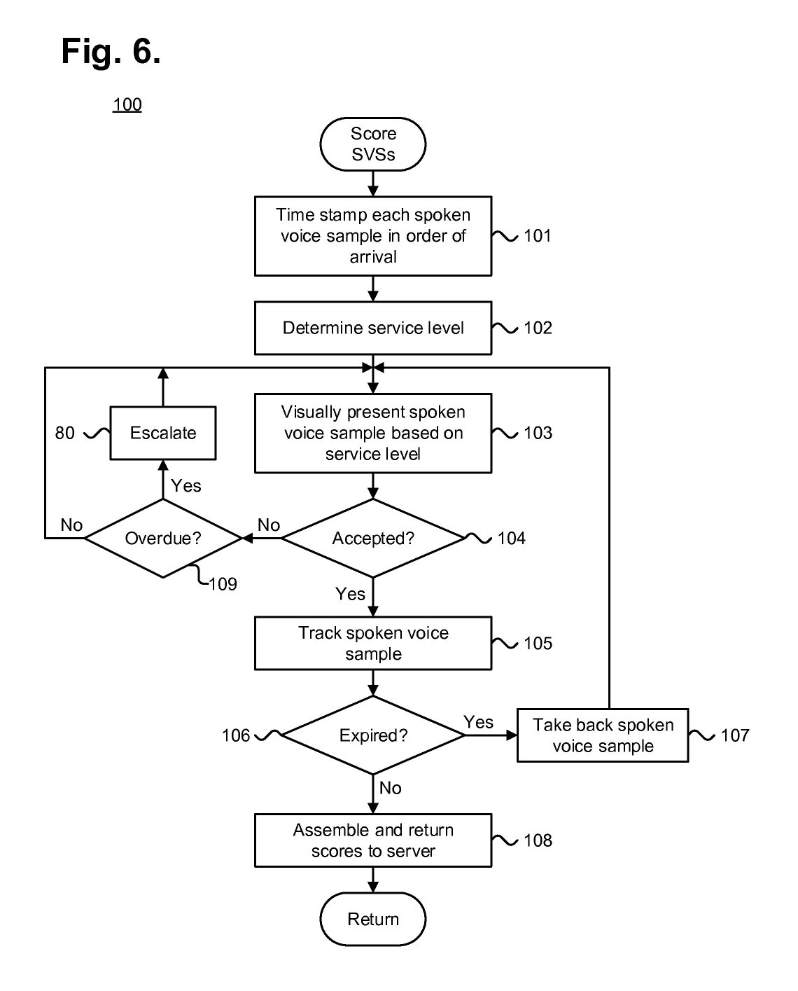

The assessment service 13 determines the engaging persona candidate's social competence in terms of vocal behavior 31 through a two-part qualitative-quantitative analysis. First, the spoken voice samples 35 are qualitatively scored by raters 22a,b,c in each of the voice cues 26 (step 86). The raters 22a,b,c manually listen to and score each sample for each of the voice cues 26. The scores grade the individual's speech along a discrete scale for each voice. In a further embodiment, the assignment of spoken voice samples 35 to raters 22a,b,c can be controlled by the assessment service 13 based on level of service, as further described infra with reference to FIG. 6. In a still further embodiment, the qualitative scores 36 can be assigned through automated voice processing, rather than manually by raters 22a,b,c. Second, upon their completion, the scores for the spoken voice samples 35 are assembled together by the assessment service 13 (step 87) and processed into quantitative measures (steps 88-90), as follows. For each phonetic analytic 25 (step 88), the (qualitative) voice cue scores 36 for that analytic are multiplied by their assigned weights and added together to form a weighted (quantitative) phonetic analytic 37 (step 89). Processing continues for each remaining phonetic analytic (step 90). The vocal behavior risk assessment is then formed from the calculated phonetic analytics (step 91) and provided to as results of the interview.

Service levels allow a patron of the assessment service 13 to get interview results within an agreed-upon time frame, or other criteria. Ensuring timely completion of skills assessments 31, however, depends to a large extent upon how quickly raters 22a,b,c are able to score spoken voice samples 35. FIG. 6 is a flow diagram showing a routine 100 for scoring spoken voice samples for use in conjunction with the method 80 of FIG. 5. The assessment service 13 controls the ordering of spoken voice samples 35 pending completion in the job queue 29. Each spoken voice sample 35 is time-stamped in order of arrival from an engaging persona candidate 15 (step 101) and, based on the patron for whom the candidate is interview, the applicable service level is determined (step 102). The spoken voice samples 35 are visually presented in the queue 29 based on the service level (step 103). For instance, the highest service level could promise completed skills assessments within an hour of the engaging persona candidate's interview and the assessment service 13 would place that patron's candidates' spoken voice samples 35 at the top of the queue 29 to encourage fast rater turnaround. Upon acceptance for scoring by a rater 22a,b,c (step 104), the assessment service 13 tracks the progress of the spoken voice sample 35 (step 105). If the preset time allotted for completion has expired (step 106), the spoken voice sample 35 is taken back from the rater 22a,b,c (step 107) and placed back into the job queue 29 based on service level (step 103). Otherwise if scoring has been timely completed (step 106), the voice cue scores are assembled together and returned to the server 12 for quantitative processing (step 108). In addition, the assessment service 13 tracks the assignment of spoken voice samples 35 that may become overdue (step 109), that is, samples that are still in the queue 29 and have yet to be accepted by a rater 22a,b,c for scoring. In appropriate situations, the handling of an overdue spoken voice sample 35 will be escalated (step 80) to a higher authority, such as a supervisor, who can then manually intervene, or an overseer procedure, which can automatically intervene, and thereby ensure that the overdue spoken voice sample 35 is given to a rater 22a,b,c expeditiously for scoring.

While the invention has been particularly shown and described as referenced to the embodiments thereof, those skilled in the art will understand that the foregoing and other changes in form and detail may be made therein without departing from the spirit and scope.

What is claimed is:

1. A computer-implemented system for quantitatively assessing vocal behavioral risk, comprising:
a database configured to store:
a plurality of vocal cues that qualitatively describe speech characteristics and phonetic analytics that quantitatively describe vocal behavior; and
spoken voice samples provided by an engaging persona candidate;
a processor and a memory configured to store code executable by the processor and comprising:
a mapping module configured to map one or more of the voice cues to each phonetic analytic and to assign a weight to each of the mapped voice cues;
a scoring module configured to assemble scores assigned to the spoken voice samples for each of the voice cues and calculate the phonetic analytics as a function of the scores for each mapped voice cue and the mapped voice cue's assigned weight; and
a vocal behavior risk assessment formed from the phonetic analytics.

2. A system according to claim 1, wherein at least one of:
the voice cues are stored along a discrete continuum, and
each spoken voice sample is specified as comprising scripted prose and spontaneous dialogue, each of which receive the scores for each voice cue.

3. A system according to claim 1, wherein at least one of:
one of the phonetic analytics is defined as a vocal behavior risk assessment representative of the vocal engagement of the engaging persona candidate, and
one of the phonetic analytics into a vocal behavior risk assessment representative of the vocal clarity of the engaging persona candidate.

4. A system according to claim 1, further comprising:
a reporting module configured to combine the vocal behavior risk assessment with assessments of one or more of comprehension and dialogue.

5. A system according to claim 1, wherein the voice cues are defined as comprising one or more of articulation accuracy, voice quality, vocal variety, fluency, and vocal emphasis.

6. A system according to claim 1, further comprising:
a server, comprising a processor and a memory configured to store code executable by the processor and comprising:
a queue of pending jobs configured to centrally collect the spoken voice samples into in temporal order of arrival;
a job scheduler configured to offer each spoken voice sample in the queue for qualitative scoring by a rater; and
a score processor configured to receive the scores assigned to the spoken voice samples for each of the voice cues following completion of the qualitative scoring.

7. A system according to claim 6, further comprising:
a tracking module configured to track each spoken voice sample following removal from the queue, and to expire the removal of the spoken voice sample after a preset amount of time.

8. A system according to claim 6, further comprising one of:
a job assignment module configured to permit the removal of the spoken voice samples from the queue in any order; and
a job assignment module configured to permit the removal of the spoken voice samples from the queue in first-in, first-out order.

9. A system according to claim 6, further comprising:
a plurality of levels of service for the vocal behavior risk assessment with higher levels of service providing enhanced services,
wherein job scheduler is further configured to the visually prioritize the spoken voice samples in the queue based on the level of service to which the spoken voice sample corresponds.

10. A system according to claim 9, wherein the service levels are structured based on time-to-completion.

11. A system according to claim 10, further comprising:
an escalation module configured to escalate overdue scoring of one such spoken voice sample if the time-to-completion has been exceeded.

12. A system according to claim 1, further comprising:
a Web-based portal with which to access the spoken voice samples and the vocal behavior risk assessment.

13. A computer-implemented method for quantitatively assessing vocal behavioral risk, comprising the steps of:
defining a plurality of vocal cues that qualitatively describe speech characteristics and phonetic analytics that quantitatively describe vocal behavior;
mapping one or more of the voice cues to each phonetic analytic and assigning a weight to each of the mapped voice cues;
storing spoken voice samples provided by an engaging persona candidate;
assembling scores assigned to the spoken voice samples for each of the voice cues and calculating the phonetic analytics as a function of the scores for each mapped voice cue and the mapped voice cue's assigned weight; and
forming a vocal behavior risk assessment from the phonetic analytics,
wherein the steps are performed on a programmed computer.

14. A method according to claim 13, further comprising one of the steps of:
scoring the voice cues along a discrete continuum; and
specifying each spoken voice sample as comprising scripted prose and spontaneous dialogue, each of which receive the scores for each voice cue.

15. A method according to claim 13, further comprising the steps of at least one of:
defining one of the phonetic analytics as a vocal behavior risk assessment representative of the vocal engagement of the engaging persona candidate; and
defining one of the phonetic analytics into a vocal behavior risk assessment representative of the vocal clarity of the engaging persona candidate.

16. A method according to claim 13, further comprising the step of:
combining the vocal behavior risk assessment with assessments of one or more of comprehension and dialogue.

17. A method according to claim 13, further comprising the step of:
defining the voice cues as comprising one or more of articulation accuracy, voice quality, vocal variety, fluency, and vocal emphasis.

18. A method according to claim 13, further comprising the steps of:
centrally collecting the spoken voice samples into a queue of pending jobs in temporal order of arrival;
offering each spoken voice sample in the queue for qualitative scoring by a rater; and
receiving the scores assigned to the spoken voice samples for each of the voice cues following completion of the qualitative scoring.

19. A method according to claim 18, further comprising the steps of:
tracking each spoken voice sample following removal from the queue; and
expiring the removal of the spoken voice sample after a preset amount of time.

20. A method according to claim 18, further comprising one of the steps of:
permitting the removal of the spoken voice samples from the queue in any order; and
permitting the removal of the spoken voice samples from the queue in first-in, first-out order.

21. A method according to claim 18, further comprising the steps of:
offering a plurality of levels of service for the vocal behavior risk assessment with higher levels of service providing enhanced services; and
visually prioritizing the spoken voice samples in the queue based on the level of service to which the spoken voice sample corresponds.

22. A method according to claim 21, further comprising the step of:
structuring the service levels based on time-to-completion.

23. A method according to claim 22, further comprising the step of:
escalating overdue scoring of one such spoken voice sample if the time-to-completion has been exceeded.

24. A method according to claim 13, further comprising the step of:
providing a Web-based portal with which to access the spoken voice samples and the vocal behavior risk assessment.

25. A non-transitory computer readable storage medium storing code for executing on a computer system to perform the method according to claim 13.

26. A computer-implemented apparatus for quantitatively assessing vocal behavioral risk, comprising:
means for defining a plurality of vocal cues that qualitatively describe speech characteristics and phonetic analytics that quantitatively describe vocal behavior;
means for mapping one or more of the voice cues to each phonetic analytic and means for assigning a weight to each of the mapped voice cues;
means for storing spoken voice samples provided by an engaging persona candidate;
means for assembling scores assigned to the spoken voice samples for each of the voice cues and means for calculating the phonetic analytics as a function of the scores for each mapped voice cue and the mapped voice cue's assigned weight; and
means for forming a vocal behavior risk assessment from the phonetic analytics.
